(19) United States
(12) Patent Application Publication
(10) Pub. No.: US 2009/0297261 A1
(43) Pub. Date: Dec. 3, 2009

(54) SYSTEM FOR ASSEMBLING TWO ROTARY PARTS TOGETHER BY FLANGES

(75) Inventor: Claude Marcel MONS, Savigny Le Temple (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: SNECMA, Paris (FR)

(21) Appl. No.: 12/473,718

(22) Filed: May 28, 2009

(30) Foreign Application Priority Data
May 29, 2008 (FR) 08 53492

(51) Int. Cl. F16D 1/033

(52) U.S. Cl. 403/337

(57) ABSTRACT

The invention relates to a system of assembling together two rotary parts by means of flanges, said flanges forming a cylindrical passage of diameter D1 and of length L1.

In characteristic manner, the system comprises:
a bolt having a head and a shank that presents a first segment and a second segment that is threaded, said first segment presenting a maximum diameter D2 that is greater than D1; and
a nut of thread suitable for co-operating with the threaded second segment and presenting a plane first face suitable for bearing against the outside face of the second flange, whereby the first segment is caused to engage tightly in the cylindrical passage and the two parts are secured to each other by tightening the nut on the threaded second segment.

The invention relates to a system for assembling two rotary parts together by flanges.

### BACKGROUND OF THE INVENTION

Said flanges are annular or scalloped and they include assembly holes. The first flange is suitable for being pressed against the second flange so that a hole in the first flange comes into alignment with a hole in the second flange, thereby forming a cylindrical passage of diameter D1 and length L1.

Such cylindrical passages are thus regularly spaced apart around the circumference of the two flanges for assembling together, and for each of these cylindrical passages it is necessary to put fastener means into place for tightly assembling together the two rotary parts that are to be secured one to the other.

For this purpose, an assembly of the kind shown in FIG. 1 is generally used: the cylindrical passage 30 going through both flanges 10 and 20 receives a smooth first segment 42 of the shank of a bolt 40. The shank of the bolt 40 includes, at its end remote from its head 41, a threaded second segment 44 that lies outside the cylindrical passage 30 and that co-operates with a nut 50 to block the two flanges 10 and 20 in position relative to each other, thereby securing the two parts carrying the flanges 10 and 20 together so as to enable them to rotate in common.

In the configuration visible in FIG. 1, it is the usual practice to have zero interference between the wall of the cylindrical passage 30 and the smooth first segment 42 of the shank of the bolt 40 that is likewise cylindrical in shape and circular in section, with this being done both to limit slack for the bolt in the cylindrical passage 30 and to enable the smooth first segment 42 of the shank of the bolt 40 to be engaged in the cylindrical passage 30 without any need to exert particular force.

This zero interference corresponds to the diameter of the smooth first segment 42 of the shank of the bolt 40 fitting the diameter of the cylindrical passage 30, which means there are points of contact between the wall of the cylindrical passage 30 and the smooth first segment 42 of the shank of the bolt 40.

Thereafter, the nut 50 is mounted on the threaded second segment 44 with which it co-operates by screw-fastening so that once it has been tightened, as shown in FIG. 1, the nut 50 comes to bear against the flange 20, while the head 41 of the bolt bears against the flange 10. This situation is obtained because the threaded second segment 44 extends a smooth first segment 42 that itself presents a length equal to the length L1 of the cylindrical passage 30, i.e. equal to the sum of the thicknesses of the flanges 10 and 20.

Nevertheless, in order to compensate the large shear forces that are exerted on the shank of the bolt in this assembly and that are induced by rotary torque during rotation of the rotary parts, a large number of bolts are put into place around the flanges 10 and 20.

In order to minimize these risks of the bolts shearing, bolts are provided that are sufficiently strong by overdimensioning them and/or by making them out of materials that present great strength.

Furthermore, because the fit between each of the bolts 40 and the corresponding cylindrical passage 30 is not identical in all cases, forces are distributed unequally, thereby creating local stresses that are higher in certain positions, thus giving rise to risks of fatigue damage to the flanges 10 and 20 of the rotary parts. Fatigue stresses run the risk of generating cracks in the flanges 10 and 20 at the locations of the holes 12 and 22 forming the cylindrical passages 30.

In addition, if the interference is small, but negative, a certain amount of slack appears between the wall of the cylindrical passage 30 and the smooth first segment 42 of the shank of the bolt, which can end up giving rise to a small amount of slip between the two flanges 10 and 20.

According to U.S. Pat. No. 4,557,033, plastic deformation is used by cold-expanding the assembly holes prior to inserting the bolts with zero interference, for the purpose of improving the fatigue strength of the two assembled-together flanges.

Under such circumstances, it is therefore necessary to treat all of the assembly holes in both flanges.

Rotary parts assembled together by annular flanges are to be found in particular in the field of turbomachines along the rotor line, for example in order to assemble together the two segments of the rotor shafts, or to attach disks, in particular turbine disks, or more precisely the trunions, or even the inter-stage labyrinth seals.

It so happens that these parts that are connected together by flanges are forged parts, e.g. made of nickel alloy, using standard methods (hammering, pressing, or rolling) so that their lifetime is generally given by the shape factors of the flanges (holes and scallops) and by the local microstructure of the material, which material is generally coarser and therefore more fragile in the flanges than in the cores of the parts.

### OBJECT AND SUMMARY OF THE INVENTION

An object of the present invention is to provide an assembly system and method that enables the drawbacks of the prior art to be overcome, and in particular that makes it possible to enable assembly to be simple and reliable, minimizing any risk of damaging the flange-mounting holes, and also being suitable for being taken apart in order to enable regular and non-destructive inspection to be performed on the assembly holes in the flanges of rotary parts.

To this end, the assembly system of the present invention comprises:

a bolt having a head and a shanks that present a first segment extending the head and a second segment that is threaded, the head having a bearing face facing towards the body, which bearing face is plane and suitable for coming into contact against the outside face of the first flange, said first segment presenting a maximum diameter D2 greater than D1, said second segment presenting a diameter D3 that is less than D1; and

a nut of thread suitable for co-operating with the threaded second segment and presenting a plane first face suitable for bearing against the outside face of the second flange, thereby enabling the first segment to be engaged tightly in the cylindrical passage and the two parts to be secured to each other by tightening the nut onto the threaded second segment.

The invention also provides a method of assembling together two rotary parts by means of flanges, said flanges having assembly holes, and said method comprising the following steps:

a) pressing the first flange against the second flange so that a hole in the first flange comes into alignment with a hole in the second flange, thereby forming a cylindrical passage of diameter D1 and of length L1;

b) providing a bolt having a head and a shank that presents a first segment extending the head and a second segment that is threaded, the head having a bearing face facing towards the body, which bearing face is plane and suitable for coming against the outside face of the first flange, said first flange presenting a maximum diameter D2 greater than D1, said second segment presenting a diameter D3 less than D1;

c) inserting the shank of the bolt by force into the passage so that the first segment is engaged tightly in the passage and the head of the screw lies beside the first flange;

d) providing a nut with a thread that is suitable for co-operating with the threaded second segment and that presents a plane first face; and

e) mounting the nut on the threaded second segment by screw tightening at least until the plane first face of the nut comes to bear against the outside face of the second flange, and the bearing face of the head comes to bear against the outside face of the first flange.

In this manner, it can be understood that because the first segment presents a maximum diameter D2 greater than the diameter D1 of the cylindrical passage, positive interference is established between the first segment of the bolt and the cylindrical passage.

In this way, the invention establishes a mechanical connection by compression between the first segment of the bolt and the cylindrical passage, thereby making it possible, while transferring rotor torque, to avoid any movement between the bolt and the flanges, and in particular any shearing. Because of this local compression stress, fatigue phenomena are limited, as is the initiation of fatigue cracking in the material constituting said flanges.

The strength, and thus the lifetime, of the bolt is thus significantly improved, but without that requiring the bolt to be overdimensioned.

The invention also serves to lengthen the lifetime of the flanges, so it is possible to envisage implementing simpler forging ranges and/or reducing the size of the forging blanks since a metallurgical structure close to that of the skin of the forging blanks can become acceptable.

This solution also presents the additional advantage of making it possible to block the bolt in its housing, thereby ensuring it does not drop out accidentally during disassembly.

Overall, by means of the solution of the present invention, it is possible to provide an assembly that is reliable, putting the shank of the bolt situated in the cylindrical passage into compression and also putting the material of the assembled flanges into compression, and achieving this without requiring any special assembly tooling, since it is the nut that is used to cause the first segment of the bolt to advance into the cylindrical passage.

It can also be observed that the improvement in the properties of the bolt provided by the assembly system and method can optionally make it possible to use material of a lower grade.

### BRIEF DESCRIPTION OF THE DRAWINGS

Other advantages and characteristics of the invention appear on reading the following description made by way of example and with reference to the accompanying drawings, in which:

FIG. 1, described above, is a fragmentary and diagrammatic section view of a prior art assembly system;

FIG. 2 is a fragmentary and diagrammatic section view of an assembly system in a first embodiment of the invention;

FIG. 3 is a view similar to FIG. 2 for a variant embodiment; and

FIG. 4 is a fragmentary and diagrammatic section view of an assembly system in a second embodiment of the invention.

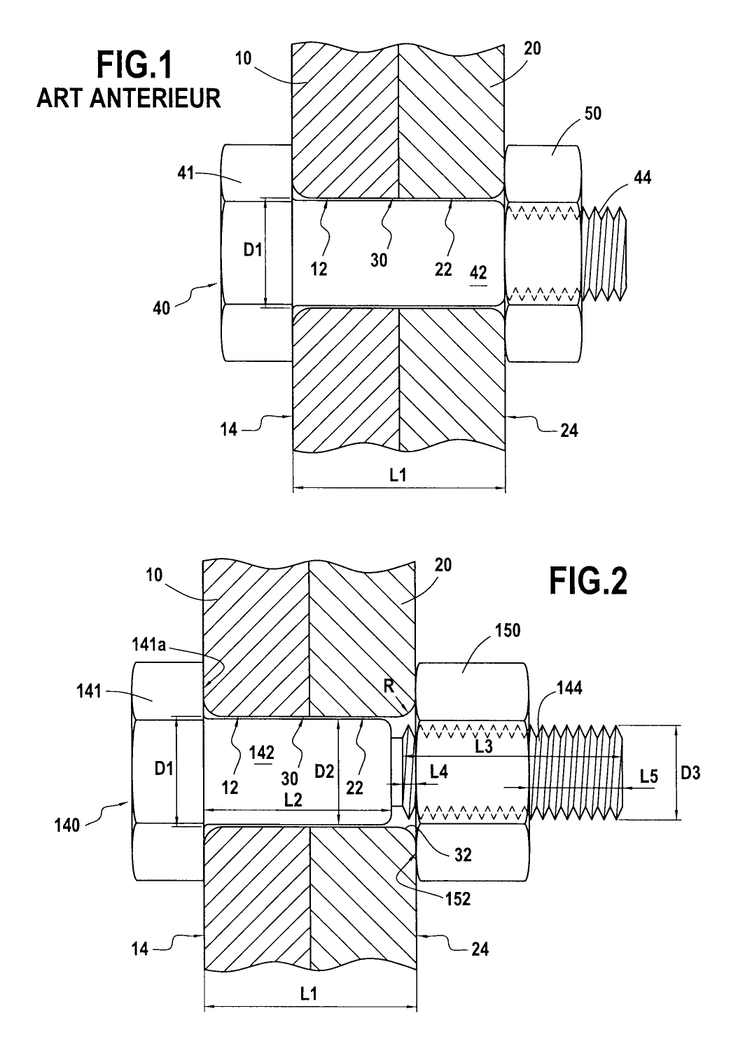

### MORE DETAILED DESCRIPTION

As can be seen in FIG. 2, use is made in the invention of a bolt 140 that is configured in a special way for the purpose of assembling together the flanges 10 and 20 via their assembly holes 12 and 22 placed in register to form the cylindrical passage 30.

The head 141 of the bolt is flat, and has a plane bearing face 141a that faces towards the shank of the bolt and that is suitable for coming into contact against the outside face 14 of the first flange 10.

The shank of the bolt 140 comprises a first segment 142 of length L2 that extends the head 141 and that is designed to be received in the cylindrical passage 30 of diameter D1, followed by a second segment 144 of length L3 that extends the first segment 142 and that is threaded.

In characteristic manner, the first segment 142 presents a maximum diameter D2>D1 so as to constitute positive interference when the first segment 142 is placed in the cylindrical passage 30.

Provision is made for the maximum diameter D2 of the first segment 142 to be at least 1% greater than the diameter D1 of the cylindrical passage 30, and preferably to be greater than the diameter D1 of the cylindrical passage 30 by more than 2% to 3%.

The threaded second segment 144 presents a diameter D3 that is less than D1 and a length L3 that is substantially equal to or greater than the length L1 of the cylindrical passage.

In this way, the second segment 144 can be engaged without friction in the passage 30 from beside the first flange 10 and can enable the thread of the second segment 144 to co-operate with the thread of a nut 150 placed beside the second flange 20.

The nut 150 presents a plane first face 152 facing towards the outside face 24 of the second flange 20.

Thus, by tightening the nut 150 on the threaded second segment 144, the plane first face 152 of the nut 150 is brought to bear against the outside face 24 of the second flange 20, and thus enables the first segment 142 to be advanced and engaged tightly in the cylindrical passage 30.

The nut 150 is screwed along the threaded second segment 144 until the plane first face 152 of the nut comes to bear against the outside face 24 of the second flange 20, and then the nut 150 continues to be tightened while the first segment 142 penetrates into and is forced along the cylindrical passage until it reaches a first position in which the bearing face 141a of the head of the bolt 140 comes against the outside face 14 of the first flange 10.

This serves to assemble together the two parts carrying the flanges 10 and 20 that are secured to each other.

It will be understood that during this assembly, if the nut 150 continues to be tightened beyond the first position, then the shank of the bolt is put into traction, like a tension spring, thereby constituting a second position or assembly position.

It is preferable to use a lubricant so as to limit the torque required for tightening the nut 150 in order to cause the first segment 142 constituting the interference fit portion, to penetrate into the cylindrical passage 30 and become blocked therein.

In addition, it is possible to use a self-locking nut 150 so as to prevent any movement of the nut 150 relative to the threaded second segment 144.

Preferably, as can be seen in the figures, the first segment 142 of the bolt 140 presents a length L2 that is shorter than L1, i.e. shorter than the sum of the thicknesses of the two flanges 10 and 20.

This avoids any contact between the first segment 142 and the opening 32 of the cylindrical passage 30 in the outside face 24 of the second flange 20, thereby minimizing stresses at that location.

In section, the opening 32 forms a filet of radius R that is preferably greater than the length L4 of the residual thread on the threaded second segment 144, i.e. the thread that remains inside the cylindrical passage 30 in the first position or the second position. This precaution makes it possible to further reduce the stresses at the opening 32 of the cylindrical passage 30.

The positive interference used corresponds to a few hundredths of a millimeter or to 1- or 2-tenths of a millimeter and achieves an improvement in ability to withstand fatigue by a factor lying in the range 2 to 5 compared with free surfaces (negative interference).

In the first embodiment of FIG. 2, the first segment 142 of the bolt presents a longitudinal profile of the rounded cylindrical type: the first segment 142 is then made in the form of a circular section cylinder of diameter D2, except at its ends. At the end beside the thread (to the right in the figures) the diameter of the first segment 142 decreases progressively, forming a filet, and at the end beside the head of the bolt (to the left in the figures) the diameter of the first segment 142 increases progressively, forming a filet that is received in the assembly hole 12, which is itself chamfered at its corresponding end.

Provision is made for the length of the shank of the bolt 140 (first segment 142 plus second segment 144) to be longer than the sum of the length L1 of the passage 30 plus the length of the nut 150 so that after the nut 150 has been screwed into the second position, the threaded second segment 144 projects beyond the nut 150 over a distance L5.

In a preferred disposition, as can be seen in FIGS. 2 to 4, the distance L5 is greater than or equal to three times the pitch of the thread of the second segment 144 so that at least three thread crests are apparent: having three thread crests visible along L5 constitutes visual means for identifying that the nut 150 has been tightened appropriately. In addition, it is preferred to use nuts 150 of the self-locking type.

The bolt is removed by unscrewing the nut and then by forced extraction of the bolt 140 from the passage 30, e.g. by an actuator bearing against the head 141 of the bolt 140 under guidance from a cylinder bearing against the outside face 14 of the first flange 10.

This makes it easy to remove and then reassemble the bolt 140 and the nut 150.

Furthermore, during disassembly, with the bolt 140 still blocked in the cylindrical passage 30 after the nut 150 has been unscrewed, there is no danger of the bolt 140 dropping out accidentally.

It will be understood that reassembly is performed like initial assembly, without any special tool since it is tight screwing the nut 150 that enables the first segment 142 of the bolt 140 to be put into place in the cylindrical passage 30.

In this way, with the rotary parts of turbomachines, it is possible to inspect the assembly holes in flanges by non-destructive techniques such as penetrant fluid inspection, magnetoscopy, eddy currents, etc.

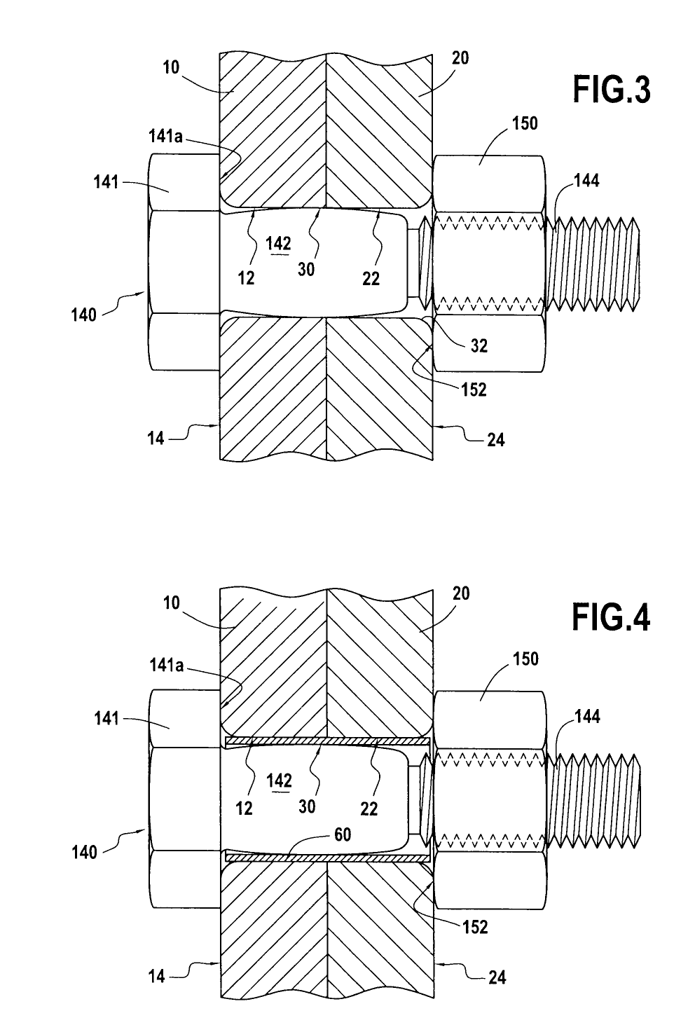

The variant embodiment shown in FIG. 3 is identical to the first embodiment of FIG. 2 except concerning the shape of the first segment 142 of longitudinal profile, which shape is no longer cylindrical and of circular section of diameter D2, but instead is oblong. It is possible to provide a longitudinal profile that is elliptical. In this configuration, the interference surface between the first segment 142 and the wall of the cylindrical passage 30 is smaller.

With reference to FIG. 4, there can be seen a second embodiment that differs from the first embodiment in that the assembly system also includes a cylindrical bushing 60 disposed in each pair of aligned assembly holes 12 and 22, thereby defining said cylindrical passage 30 of diameter D1 that is to receive the first segment 142 of the bolt.

In this situation, the cylindrical bushing 60 is itself mounted with zero or negative interference in the aligned holes 12 and 22, prior to mounting and tightening the bolt 140.

The outside diameter of the bushing 60 is equal to or less than the diameter of the aligned holes 12 and 22. Also, the outside diameter of the bushing 60 is greater than the maximum diameter D2 of the first segment 142 of the shank of the bolt 140.

In addition, the inside diameter of the bushing 60 constitutes the diameter D1 and it is less than the maximum diameter D2 of the first segment 142 of the shank of the bolt 140, and that therefore enters into positive interference inside the bushing 60.

Thus, in this configuration, it is the passage of the bolt 140 that puts the bushing 60 and the holes in the flanges (assembly holes 12 and 22) into compression.

In FIG. 4, the bushing 60 presents a length that is substantially equal to the length L1 of the passage 30. Provision could be made (option not shown) for the bushing 60 to be shorter than the passage 30, providing the bushing extends in both of the holes 12 and 22, at least in the location where they are to come into positive interference with the first segment 142 of the bolt 140.

The bushing 60 may be used for example when it is necessary to use a different material for making contact with the first segment 142 of the bolt 140, whether for mechanical reasons or for metallurgical and galvanic reasons when the materials constituting the bolts 140 and one or both of the flanges 10 and 20 run a risk of galvanic corrosion. The bushing 60 also makes it possible to avoid injuring the diameters of the holes in the flanges (assembly holes 12 and 22) during assembly.

FIG. 4 shows the first segment 142 of the bolt 140 with a longitudinal profile that is oblong, however it could also be a rounded cylindrical profile as shown in FIG. 2 (configuration not shown).

In another variant (not shown) of the first and second embodiments, provision is made for the distance L5 to be less than three times the pitch of the thread of the second segment 144, but greater than a single pitch of the thread of the second segment 144, so that at least one entire thread remains apparent: the presence of this single thread projecting can thus constitute visual means for identifying that the nut 150 has been tightened appropriately.

Nevertheless, in this configuration, and for greater accuracy, it is possible to measure the elongation of the shank of the bolt 140 that is in traction, like a tension spring: an optimum value is of the order of 0.7 times the elastic limit of the material constituting the bolt 140.

Under such circumstances, since the bolt is shorter, it is more compact and gives rise to less wind resistance when the parts carrying the flanges are rotating at high speed.

What is claimed is:

1. A system for assembling two rotary parts together by means of flanges, said flanges including assembly holes, the first flange being suitable for pressing against the second flange in such a manner that a hole in the first flange is in alignment with a hole in the second flange, thereby forming a cylindrical passage of diameter D1 and of length L1, wherein the system comprises:
a bolt having a head and a shank that presents a first segment extending the head and a second segment that is threaded, the head having a bearing face facing towards the body, which bearing face is plane and suitable for coming into contact against the outside face of the first flange, said first segment presenting a longitudinal profile of the rounded cylindrical, oblong, or elliptical type, and a maximum diameter D2 greater than D1, said second segment presenting a diameter D3 that is less than D1; and
a nut of thread suitable for co-operating with the threaded second segment and presenting a plane first face suitable for bearing against the outside face of the second flange, thereby enabling the first segment to be engaged tightly in the cylindrical passage and the two parts to be secured to each other by tightening the nut onto the threaded second segment.

2. An assembly system according to claim 1, wherein the first segment of the bolt presents a length shorter than L1.

3. An assembly system according to claim 1, wherein the length of the shank of the bolt is greater than the sum of the length L1 of the passage plus the length of the nut, such that after the nut has been tightened, the threaded second segment projects beyond the nut by a distance L5.

4. An assembly system according to claim 3, wherein the distance L5 is greater than one pitch of the thread of the second segment.

5. An assembly system according to claim 3, wherein the distance L5 is greater than or equal to three times the pitch of the thread of the second segment.

6. An assembly system according to claim 1, further comprising a cylindrical bushing placed in said aligned assembly holes and that defines the cylindrical passage of diameter D1 that receives the first segment of the bolt.

7. An assembly system according to claim 1, wherein the maximum diameter D2 of the first segment is greater than the diameter D1 of the cylindrical passage by at least 1%.
